(19) United States
(12) Patent Application Publication
(10) Pub. No.: US 2012/0253745 A1
(43) Pub. Date: Oct. 4, 2012

(54) SYSTEM AND METHOD FOR TESTING PERFORMANCE OF MOBILE APPLICATION SERVER

(75) Inventors: Karthikeyan Balaji Dhanapal, Bangalore (IN); Puneet Gupta, Bangalore (IN)

(73) Assignee: INFOSYS TECHNOLOGIES LIMITED, Bangalore (IN)

(21) Appl. No.: 13/073,429

(22) Filed: Mar. 28, 2011

(51) Int. Cl. G06F 11/30

(52) U.S. Cl. 702/186

(57) ABSTRACT

A system and method for testing performance of a mobile application server is provided. The methodology of the invention describes steps to initiate one or more instances of a mobile application using one or more test cases. The one or more instances of the mobile application are initiated in a plurality of emulations of an operating environment. The methodology further describes steps to buffer plurality of requests generated by the one or more instances of the mobile application. The methodology furthermore describes steps to invoke the plurality of buffered requests synchronously to a server based on a predefined policy. The methodology in addition describes step to measure response time taken by the server to process each of the invoked plurality of requests.

### FIELD OF INVENTION

The present invention relates to testing of mobile applications. More particularly, the present invention provides a framework to test the performance of mobile application server.

### BACKGROUND OF THE INVENTION

The development in cellular and computing technology has resulted in proliferation of smart handheld devices, such as smart phones, personal digital assistants (PDA), tablets, and so forth. To take advantage of the growing mobile computing market, companies/businesses are developing various mobile computing applications for enhancing user experience and providing e-commerce solutions to the user. For example, users of smart phones are enabled to access email, perform web browsing, carry out e-commerce activities, through respective mobile computing applications. Due to increase in mobile application usage, performance of the mobile application and retrieval of contents from these mobile applications has become a problem.

In order to ascertain the performance of a mobile application server, load testing of the mobile application server is performed. Load is defined as the work done by a computing node in a particular period of time. Each mobile computing application follows a client/server communication protocol, wherein the mobile device, having an installed mobile application initiates a request for processing behaves as a client node and the host, which is configured for performing the requested computation/processing, responds as a server. For example, various instances of a mobile web browser application are installed at respective client nodes (mobile computing devices). Thereafter, each instance of the mobile web browser application sends a request to a server for further processing. Load of the server is defined by the number of client nodes the server (configured to process request) can serve at a particular instance of time. Load is measured by the response time, i.e. the time taken for each request/query to be processed by the server.

Presently, custom load testing tools are developed to measure the performance of a particular mobile application. A developer has to develop a load testing tool, which is unique for each mobile application. This method is expensive in terms of both cost and effort. In addition, neither the architecture of the proprietary protocol is known nor the architecture can be derived by the process of re-engineering. Therefore, it is generally difficult to generate proprietary protocol requests required for testing the performance of the mobile application server.

To overcome abovementioned disadvantage of creating proprietary protocol/request various emulators are used. Typically, emulators enable the user to perceive an emulation (virtual application/environment) of the actual operating system both functionally and aesthetically. However, emulators require a dedicated tester/developer to develop corresponding request for the load testing exercise. Since, a tester can generate a single request, using an emulator, at a single instance of time, this method fails to test the actual load capacity or performance of the mobile application server.

In light of the abovementioned disadvantages, there is a need for a method and a system to provide a framework to generate multiple proprietary requests and subsequently test the mobile application server with real-time load.

### SUMMARY OF THE INVENTION

A system and computer implemented method for testing performance of a mobile application server is provided. In various embodiment of the present invention, the computer implemented method for testing performance of a mobile application server comprises initiating, using a computing device, one or more instances of a mobile application. The one or more instances of the mobile application are initiated using one or more test cases. The method further comprises buffering, using a computing device, plurality of requests generated by the one or more instances of the mobile application. The plurality of requests are generated in response to the corresponding one or more test cases. The method furthermore comprises invoking, using a computing device, the plurality of buffered requests synchronously to a server. The plurality of buffered requests are invoked based on a predefined policy. Furthermore, the method comprises monitoring, using a computing device, response time taken by the server to process each of the invoked plurality of requests.

In an embodiment of the present invention, the computer implemented method for testing performance of the mobile application server further comprises recording one or more user inputs using a computing device. The one or more user inputs are recorded automatically while a user interacts with the mobile application. The method furthermore comprises developing, using a computing device, one or more test cases based on the recorded one or more user inputs and pre-stored data.

In an embodiment of the present invention, the method for recording one or more user inputs further comprises converting the one or more recorded user inputs into one or more dynamic test scripts.

In an embodiment of the present invention, the method for developing one or more test cases further comprises processing the one or more dynamic test scripts using the pre-stored data to develop one or more corresponding test cases.

In an embodiment of the present invention, the pre-stored data includes mobile application data, such as Uniform Resource Locator (URL) address of web pages, user transaction details, and so forth.

In an embodiment of the present invention, the method for initiating one or more instances of the mobile application further comprises deploying plurality of emulations of an operating system, required to host the mobile application, in one or more computing devices. The method furthermore comprises invoking one or more instances of the mobile application in each of the deployed plurality of emulations of the operating system.

In an embodiment of the present invention, the predefined policy required for invoking the plurality of buffered requests to a server comprises at least one of number of requests buffered and predetermined time.

In an embodiment of the present invention, the method for measuring the response time taken by the server to process each of the invoked plurality of requests further comprises monitoring the request time at which each of the plurality of buffered requests is invoked synchronously to the server. The method furthermore comprises detecting the processing time at which the server responds after processing each of the plurality of invoked requests. Furthermore, the method comprises deducing the response time based on the monitored request time and detected processing time.

In an embodiment of the present invention, the computer implemented method for testing performance of the mobile application server further comprises validating, using a computing device, one or more developed test cases by analyzing the user interface of each of the one or more instances of the mobile application and pre-stored information.

In an embodiment of the present invention, the pre-stored information includes targeted screenshots of various responses of the mobile application.

In another embodiment of the present invention, the computer implemented method for testing performance of a mobile application server comprises recording one or more user inputs using a computing device. The one or more user inputs are recorded automatically while a user interacts with a mobile application. The method further comprises developing, using a computing device, one or more test cases based on the recorded one or more user inputs and pre-stored data. The method furthermore comprises initiating, using a computing device, one or more instances of a mobile application. The one or more instances of the mobile application are initiated using one or more test cases. Furthermore, the method comprises buffering, using a computing device, plurality of requests generated by the one or more instances of the mobile application. The plurality of requests are generated in response to the corresponding one or more test cases. The method also comprises invoking, using a computing device, the plurality of buffered requests synchronously to a server. The plurality of buffered requests are invoked based on a predefined policy. The method further comprises measuring, using a computing device, response time taken by the server to process each of the invoked plurality of requests.

In an embodiment of the present invention, the system for testing performance of a mobile application server comprises a central controller and a message synchronization module. The central controller, in communication with a processor, is configured to initiate one or more instances of the mobile application using one or more test cases. The message synchronization module, in communication with a processor, is configured to invoke plurality of buffered requests synchronously to the server based on a predefined policy. The message synchronization module is further configured to measure a request response time corresponding to each of the plurality of buffered requests processed at the server.

In an embodiment of the present invention, the system for testing performance of a mobile application server further comprises a recording assistant. The recording assistant, in communication with a processor, is configured to develop one or more test cases using one or more user inputs and pre-stored data.

In an embodiment of the present invention, the recording assistant is further configured to record one or more user inputs. The one or more user inputs are recorded automatically while a user interacts with the mobile application.

In an embodiment of the present invention, the system for testing performance of a mobile application server further comprises a plurality of client agents, installed in one or more computing devices. The plurality of client agents are configured to initiate one or more instances of the mobile application using the developed one or more test cases.

In an embodiment of the present invention, the message synchronization module is further configured to buffer requests generated by one or more instances of the mobile application in response to the corresponding one or more test cases.

In an embodiment of the present invention, the predefined policy used to invoke plurality of buffered requests synchronously to the server for processing, comprises at least one of number of buffered requests and predetermined time.

In an embodiment of the present invention, the plurality of client agents are further configured to capture predefined variations at the user interface of respective instances of the mobile application.

In an embodiment of the present invention, the central controller is further configured to validate one or more developed test cases by analyzing the captured predefined variations of the user interface of each of the one or more instances of the mobile application and pre-stored information.

In an embodiment of the present invention, the pre-stored information includes targeted screenshots of various responses of the mobile application.

In an embodiment of the present invention, the system for testing performance of a mobile application server further comprises a data storage module. The data storage module, in communication with a processor, is configured to store the pre-stored data and the pre-stored information.

### BRIEF DESCRIPTION OF THE ACCOMPANYING DRAWINGS

The present invention is described by way of embodiments illustrated in the accompanying drawings wherein:

FIG. 1 is a block diagram of the performance testing system environment, in accordance with an embodiment of the present invention;

FIG. 2 is a block diagram of a performance testing system employed to test performance of a mobile application server, in accordance with an embodiment of the present invention;

FIG. 3 illustrates a flowchart to test performance of a mobile application server, in accordance with an embodiment of the present invention;

FIG. 4 illustrates a screenshot of a client emulator validating login credentials, in an exemplary embodiment of the present invention; and

FIG. 5 illustrates a screenshot of a user interface of a central controller module, in an exemplary embodiment of the present invention.

### DETAILED DESCRIPTION OF THE INVENTION

A system and method to test performance of mobile application server is provided. The invention facilitates the creation of test cases utilizing recorded user inputs/actions and pre-stored data. The invention further enables various client agents to invoke multiple instances of the mobile application. Each instance of the mobile application generates requests for a server. Thereafter, the invention facilitates buffering of the generated requests and collectively forwarding the buffered requests to the server, based on a predefined rule/policy. After which, the performance of the mobile application server is measured based on the response time of each request processed by the server.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

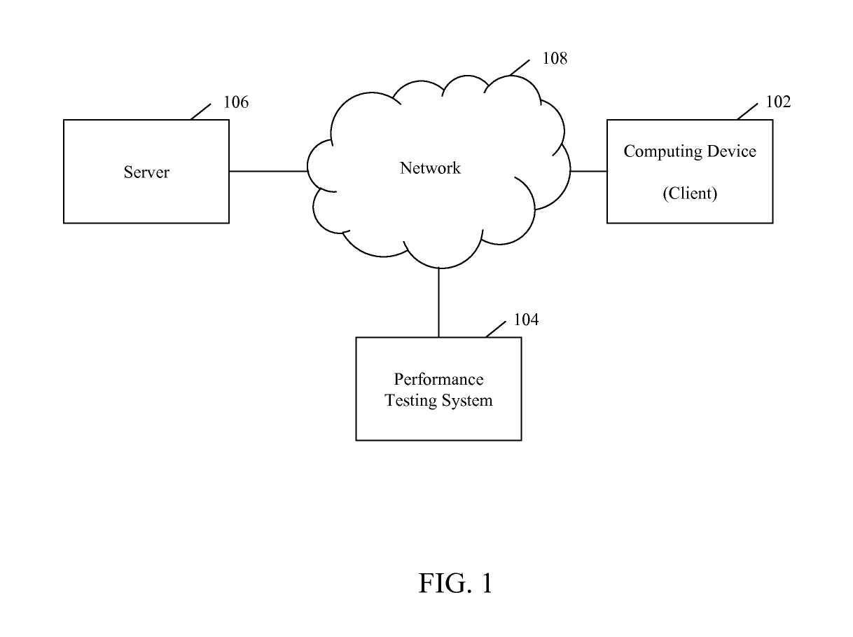

FIG. 1 is a block diagram of the performance testing system environment, in accordance with an embodiment of the present invention. The performance testing system environment comprises a Computing Device 102, a Server 106, and a Performance Testing System 104.

In various embodiments of the present invention, a mobile application, such as a web browser, an e-commerce application, an email application and so forth, is deployed in a computing device, such as a smart mobile phone, personal digital assistant (PDA), laptop and tablet. It will be apparent to a person skilled in the art that a computing device primarily comprises hardware components such as a memory, a data storage, a processor, a display, a radio device, and I/O peripherals, and an operating system, such as IOS™, Blackberry 6™, MS mobile 7™, and so forth, to enable the hardware components. Further, the mobile application is enabled to communicate with a server to perform various computations/processing.

In an embodiment of the present invention, a mobile application is invoked at the Computing Device 102. Thereafter, the Computing Device 102 communicates with the Server 106 to perform various predefined computations. In various embodiment of the present invention, the Computing Device 102 communicates with a Server 106 through a network 108, wherein the network 108 may be wired or wireless, such as Wi-Fi, Wireless Local Area Network (WLAN), Local Area Network (LAN), Global System for Mobile Communications (GSM), Code Division Multiple Access (CDMA), and so forth. In an exemplary embodiment of the present invention, an email application may be invoked at the Computing Device 102. A user of the email application is prompted to input his authentication details to access his emails. After the user enters the required authentication details, the Computing Device 102 sends the information to the Server 106 for further validation. Once the information is validated by the Server 106, the email application provides the user with the requested information. It may be apparent to a person skilled in the art that one or more computing devices, such as the Computing Device 102, may communicate with the Server 106 in a particular period of time, wherein each Computing Device 102 includes an installed email application. The multiple communications established between the Server 106 and the one or more computing devices will affect the performance of the Server 106. In an embodiment of the present invention, performance of the Server 106 is defined as the ability of the Server 106 to serve requests/queries generated by corresponding mobile applications at a particular instance of time. The performance of the Server 106 is measured by monitoring the response time taken by the Server 106 to serve each request. A request is a command/communication sent by a mobile application to the Server 106 for further processing.

In an embodiment of the present invention, the Performance Testing System 104 is enabled to measure the performance of a mobile application server, wherein the mobile application is installed in the Computing Device 102. The Performance Testing System 104 buffers each request/query generated by the mobile application included in the Computing Device 102, based on a predefined policy, such as number of requests, predetermined time and so forth. Thereafter, the Performance Testing System 104 invokes the buffered requests to the Server 106 for further processing. Subsequently, the Performance Testing System 104 measures the response time taken by the Server 106 to process each request, sent by the Computing Device 102. The response time taken by the Server 106 to process the request(s) defines the performance of the mobile application server.

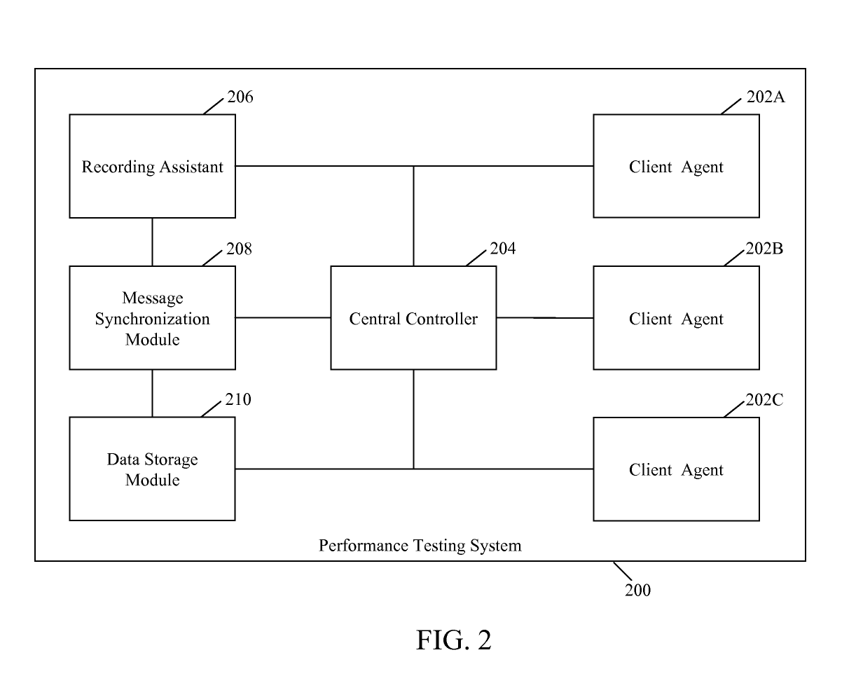

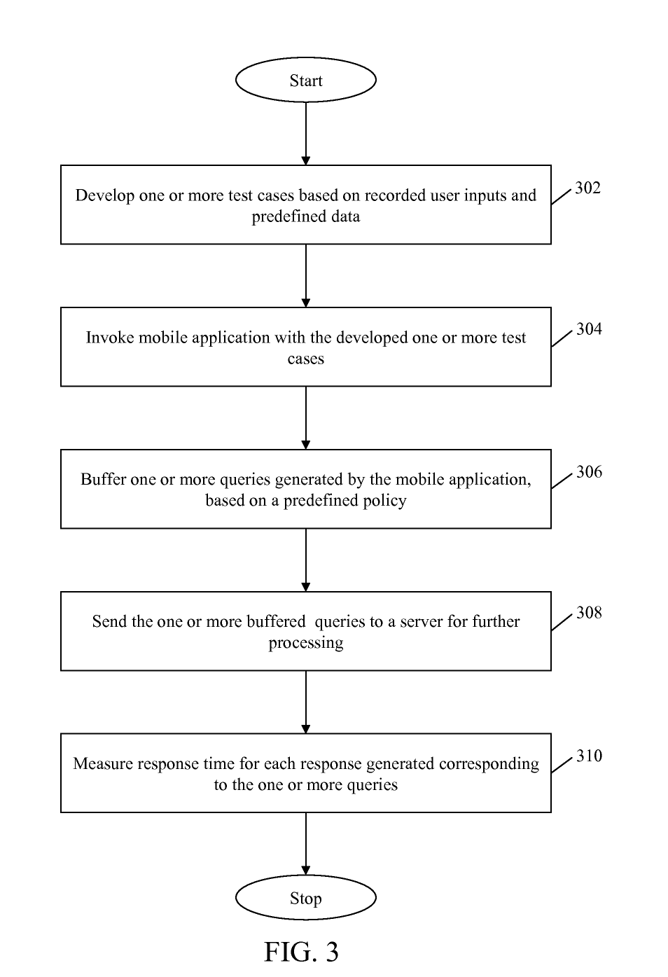

In another embodiment of the present invention, the Performance Testing System 104 emulates multiple instances of a mobile application. Thereafter, the Performance Testing System 104 monitors the user inputs/actions in the mobile application initiated at the Computing Device 102 and correspondingly generates one or more test cases based on the monitored user inputs. Subsequently, the generated one or more test cases are provided to the emulated multiple instances of the mobile application. Further, the Performance Testing System 104 stores/buffers multiple requests/queries generated by each instance of the mobile application. The buffered requests are further invoked to the Server 106 in a synchronized queue based on a predefined policy, such as number of requests, predetermined time and so forth. After which, the Performance Testing System 104 measures the response time of each of the requests processed at the Server 106. The Performance Testing System 104 is further explained in details in conjunction with FIG. 2 and FIG. 3.

FIG. 2 is a block diagram of a performance testing system employed to test performance of a mobile application server, in accordance with an embodiment of the present invention.

The Performance Testing System 200 measures the performance of a mobile application server. The Performance Testing System 200 is enabled to generate multiple requests/queries from various instances of a mobile application. In various embodiment of the present invention, the Performance Testing System 200 buffers the generated requests and thereafter executes the buffered requests to a server, such as the Server 106 (FIG. 1), based on a predefined policy. The Performance Testing System 200 comprises one or more Client Agents 202A-202C, a Central Controller 204, a Recording Assistant 206, a Message Synchronization Module 208, and a Data Storage Module 210.

In various embodiment of the present invention, the Performance Testing System 200 further comprises computing elements, such as a processor, a memory (such as RAM, ROM, and so forth), one or more I/O peripheral devices, and display device. It may be appreciated by a person skilled in the art that each of the computing elements associated/included with the Performance Testing System 200 enables the one or more Client Agents 202A-202C, the Central Controller 204, the Recording Assistant 206, the Message Synchronization Module 208, and the Data Storage Module 210 to perform various computational steps/processes.

In an embodiment of the present invention, the one or more Client Agents 202A-202C are installed either in a single computing device or in a plurality of computing devices. Each of the one or more Client Agents 202A-202C is employed to invoke an instance of a mobile application, which communicates with a server for further processing. In an embodiment of the present invention, an emulator of a mobile operating system is installed at a computing device. The emulator mimics the normal functioning of the operating environment of a particular mobile device, such as Blackberry OS™, Microsoft Mobile OS™, Palm OS™, and so forth. Further, an instance of a mobile application, the performance of which has to be tested, is initiated in the emulator. The Client Agent 202A is installed in the computing device to invoke the corresponding instance of the mobile application. The Client Agent 202A is further enabled by the Central Controller 204, to provide test cases to the mobile application and subsequently monitor the response of the mobile application.

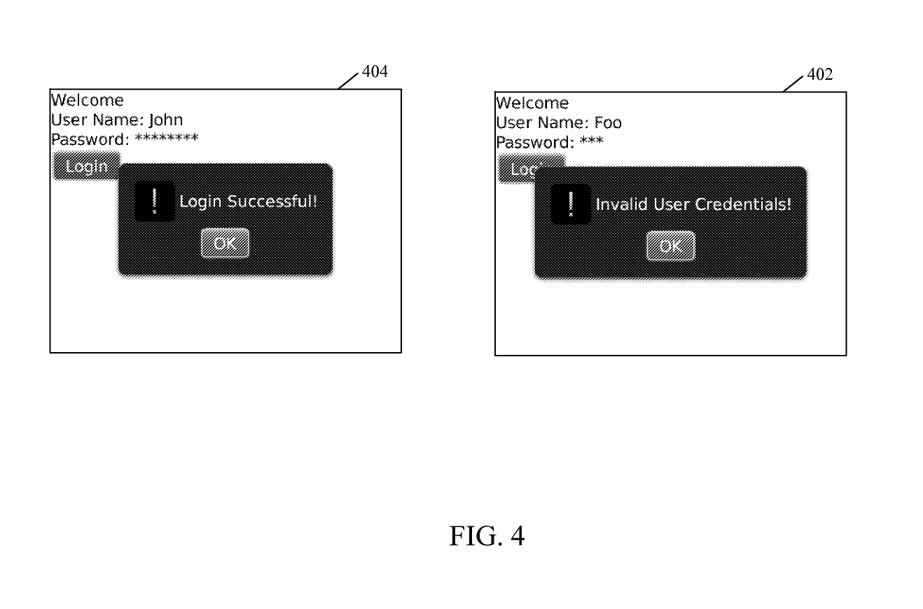

In an embodiment of the present invention, the Client Agent 202A is further configured to capture a snapshot of a predefined area of the mobile application's user interface. Thereafter, the captured snapshot is analyzed to monitor the response of the mobile application to the test case. It may be apparent to a person skilled in the art that various image comparison algorithms may be used to perform the analysis. In an embodiment of the present invention, pixel mapping is used to perform the analysis. In an exemplary embodiment of the present invention, a test case is provided to the mobile application for validating a user account. The Client Agent 202A in conjunction with the Central Controller 204 monitors the response of the mobile application by detecting visual changes in the user interface of the mobile application. Furthermore, the Client Agent 202A compares the captured snapshot to a pre-stored response snapshot to ascertain whether processing performed at the mobile application is in order. The image comparison methodology used to determine the validity of a response of a mobile application is further explained in conjunction with FIG. 4.

The Central Controller 204 controls the entire testing framework of the Performance Testing System 200. The Central Controller 204 triggers the one or more Client Agents 202A-202B, installed in either a single computing device or a plurality of computing devices, with respective test cases. Thereafter, the Central Controller 204 monitors the response of the mobile application to the test case with the help of the Client Agent 202A. As explained earlier, the Client Agent 202A captures snapshot of the user interface of the mobile application and subsequently monitors the response of the mobile application by performing image analysis in conjunction with the Central Controller 204.

In an embodiment of the present invention, the Central Controller 204 is also configured to control the Message Synchronization Module 208. The Central Controller 204 facilitates the routing of the outgoing request/query, initiated by the mobile application, to the Message Synchronization Module 208. In an embodiment of the present invention, the Central Controller 204 enables a tester to configure automated routing. Thereafter, each of the one or more requests/queries generated by the mobile application is routed automatically to the Message Synchronization Module 208 for further processing. In another embodiment of the present invention, the Central Controller 204 routes the outgoing request/query, initiated from the mobile application, to the Message Synchronization Module 208 for further processing. In an embodiment of the present invention, in response to the test case, the mobile application generates a request/query to a server for further computation/processing. The generated request on generation is automatically routed to the Message Synchronization Module 208 for synchronization, wherein the Central Controller 204 is used to configure the automatic routing of the generated requests. Each of the buffered requests is executed synchronously to the server, based on a predefined parameter.

The Recording Assistant 206 is configured to develop a test case in conjunction with the Data Storage Module 210. In an embodiment of the present invention, the Recording Assistant 206 records user inputs to develop a test script. Thereafter, the test script developed is combined with pre-stored data, retrieved from the Data Storage Module 210, to generate a test case. In an exemplary embodiment of the present invention, the Recording Assistant 206 records user's inputs, i.e. actions performed by the user to login into his bank account using a mobile banking application. The user enters his username and password and thereafter clicks the ‘ok’ key for authentication. Correspondingly, the Recording Assistant 206 records all the user actions, i.e. user clicks on the ‘username’ tab, user presses key ‘A’, user presses key ‘B’, user clicks on the ‘password’ tab, user presses key ‘C’, and so forth. The actions are recorded as a test script and the designated space for characters are dynamically updated based on data retrieved from a pre-stored file.

In an embodiment of the present invention, a pre-stored data/file, stored at the Data Storage Module 210, contains various user information, such as combinations of usernames and passwords, transaction details, and so forth, wherein the user information are utilized by the Recording Assistant 206 to generate multiple test cases. The Recording Assistant 206 generates the test cases by combining the developed test script, containing the recorded user actions, with the data retrieved from the pre-stored file. The test cases developed by the Recording Assistant 206 are further sent to the Central Controller 204 for further processing. After which, the Central Controller 204 invokes the one or more Client Agents 202A-202B with the multiple test cases, wherein each of the multiple test cases is developed by the Recording Assistant 206 to test the performance of an instance of the mobile application.

The Message Synchronization Module 208 buffers various requests from multiple instances of a mobile application. In an embodiment of the present invention, one or more Client Agents 202A-202B invoke respective instances of a mobile application with corresponding test cases. Each instance of the mobile application, in response to the corresponding test case, sends a request to the Server 106 (FIG. 1) for further processing/computation. The requests sent by various instances of the mobile application are routed to the Message Synchronization Module 208. Thereafter, the Message Synchronization Module 208 buffers the received requests, based on a predefined policy.

In an embodiment of the present invention, the predefined policy includes at least one rule to control invocation of the buffered requests to the Server 106 (FIG. 1). The at least one rule may include a predetermined number of requests (to be buffered), a time duration, and so forth. In an exemplary embodiment of the present invention, the Message Synchronization Module 208 is configured to buffer requests until a predefined number of requests, such as 100 requests, are enqueued for invocation. Alternately, a time limit policy, such as a time limit of 10 seconds, may also be defined at the Message Synchronization Module 208. Hence, in case the Message Synchronization Module 208 receives 100 requests within 10 seconds, the Message Synchronization Module 208 will invoke the entire 100 requests simultaneously. In case, the Message Synchronization Module 208 receives only 80 requests and the time limit of 10 seconds expires, then the Message Synchronization Module 208 will invoke the received 80 requests simultaneously. It may be apparent to a person skilled in the art that various other predefined policies may be defined to control the invocation of the buffered requests. The synchronous invocation of the buffered request, based on the predefined policy, is employed to simulate load at the Server 106 (FIG. 1).

In an embodiment of the present invention, the Message Synchronization Module 208 is further configured to measure request response time corresponding to each request/query. In an embodiment of the present invention, after the Message Synchronization Module 208 invokes the buffered requests to the Server 106 (FIG. 1), the Message Synchronization Module 208 awaits the server's response for each corresponding request. The Message Synchronization Module 208 stores the time, when the buffered requests are invoked to the Server 106 (FIG. 1) and correspondingly detects the time when it receives the responses for each of the invoked requests. In an embodiment of the present invention, the Message Synchronization Module 208 identifies each request with the help of an identification key such as a Uniform Resource Locater (URL), Source IP, Destination IP, Source Port number, Destination Port Number, and a Protocol. The difference between the time of sending a request and correspondingly the time of receiving a response to the request is defined as the response time of the corresponding request. The response time is used to measure the performance of the mobile application server, wherein a lower response time denotes high performance and higher response time denotes a low performance of the mobile application server.

In an embodiment of the present invention, the Message Synchronization Module 208 also measures the traffic statistics of the communication between a mobile application and the server. The traffic statistics includes information such as number of packets sent in a request, number of bytes of a request response, and so forth. In an embodiment of the present invention, after a request is buffered at the Message Synchronization Module 208, various data corresponding to the request are derived. The data derived, corresponding to the request, describes the identity of the request, the structure of the request, the number of packet contained in the request, the time when the request was received, and so forth. The data derived is further stored at the Data Storage Module 210. As explained earlier, the Message Synchronization Module 208 after invoking the buffered requests monitors for respective responses from the Server 106 (FIG. 1). Once the responses are received then the Message Synchronization Module 208 gathers information corresponding to each of the received response. The gathered information may include identification of a response, number of packets contained in a response, and so forth. In an embodiment of the present invention, the Message Synchronization Module 208 analyzes the derived data, corresponding to the request, and the gathered information corresponding to the response, to derive the traffic statistics of the communication between the mobile application and the Server 106 (FIG. 1). It may be apparent to a person skilled in the art that the data derived and the information gathered corresponding to respective requests and corresponding responses may be used for various analytical computations.

The Data Storage Module 210 stores one or more data files and information corresponding to each user's authentication details, such as username and passwords. The Data Storage Module 210 is further enabled to store various data and information corresponding to each request and responses derived by the Message Synchronization Module 208. In an embodiment of the present invention, the Recording Assistant 206 communicates with the Data Storage Module 210 to retrieve respective users' validation details to further develop corresponding test cases.

FIG. 3 illustrates a flowchart to test performance of a mobile application server, in accordance with an embodiment of the present invention.

At step 302, one or more test cases are developed based on recorded user inputs and predefined data. In an embodiment of the present invention, a user's actions/inputs are recorded while the user interacts with a mobile application through an emulator. The recorded user inputs are further converted into a test script, wherein the characters respective to user identifications are replaced by variables, which are dynamically updated. In an exemplary embodiment of the present invention, a user performs a bank transaction through a mobile application. The user inputs his username and password for authentication. After which the mobile application communicates with a server to verify the authentication details provided. After the authentication details are validated the respective transaction activity is processed. The user actions/inputs corresponding to each step is recorded, such as typing username, typing password, clicking on the confirmation button and so forth. The user actions are further transformed in a test script. In case the user inputs his username as ‘JOHN’, the information recorded is (Press ‘J’) corresponding to character ‘J’ pressed and so forth. The recorded user inputs are further combined with predefined data to develop one or more test cases. The predefined data may include various combinations of usernames and passwords for creating virtual/test user accounts.

Thereafter at step 304, the developed one or more test cases are used to invoke a mobile application. In an embodiment of the present invention, various instances of a mobile application are initiated through corresponding emulators, installed at one or more computing devices. Each of the one or more test cases is provided to a corresponding instance of a mobile application. After which, the mobile application generates one or more requests/queries to be send to a server for further processing. In an exemplary embodiment of the present invention, various instances of a mobile banking application are initiated at one or more computing devices. Further, one or more test cases are provided to each instance of the mobile banking application, wherein the one or more test cases include various respective users' authentication information. The respective instances of the mobile banking application generate one or more requests/queries in response to the corresponding one or more test cases. Each of the one or more queries is generated to be sent to a server for further processing.

At step 306, the one or more queries generated by the mobile application are buffered based on a predefined policy. In an embodiment of the present invention, the predefined policy may include but not limited to a number of queries, and a predefined time limit. As explained earlier at step 304 that each of the respective instances of the mobile application generates one or more queries in response to the one or more corresponding test cases. After which, each of the generated one or more queries is buffered based on a predefined policy. In an exemplary embodiment of the present invention, the predefined policy is defined as the number of queries, wherein the one or more queries are buffered until the total number of queries enqueue for execution is equal to 100. In another exemplary embodiment of the present invention, the predefined policy is defined as the time limit, wherein the queries are buffered until a preset time (10 sec) expires. It may be apparent to a person skilled in the art that the queries are buffered to simulate a greater load on the server and subsequently to measure the performance of the mobile application server based on the buffered one or more queries. Various predefined policies may be defined based on the requirements of the performance test.

At step 308, the one or more buffered queries are sent to a server for further processing. In an embodiment of the present invention, the one or more buffered queries, based on a predefined policy, are synchronously sent to the server for further processing/computation. The one or more queries are buffered to stimulate a greater load on the server, wherein load increases proportionally to the number of queries. The server is required to process each of the one or more queries and subsequently respond to the query to further complete the processing of the request. In an exemplary embodiment of the present invention, one or more test cases are used to invoke respective instances of a mobile application. Thereafter, each instance of the mobile application respectively generates a query to be sent to a server for further processing. The collective one or more queries corresponding to all instances of the mobile application are buffered based on a predefined policy. Consequently, the buffered one or more queries are sent simultaneously to a server to stimulate load. After which, the server responds to each query and generates a response after processing the corresponding query.

At step 310, a response time for each response generated corresponding to the one or more queries is measured. In an embodiment of the present invention, after the server generates a response corresponding to each query, a response time is measured to assess the performance of the mobile application server. The response time for each query is defined by the time taken for the server to process and send an output back to the mobile application. In an exemplary embodiment of the present invention, a time (T₁) at which each of the buffered one or more queries are sent to the server is recorded. Subsequently, once the server sends a response to the received query, a time (T₂) is recorded. The difference between T₂ and T₁ denotes the response time for a query, i.e. Response time=T₂−T₁. A lower value of response time denotes a higher performance of the mobile application server. Alternately, a higher value of response time denotes a lower performance of the mobile application server. It may be apparent to a person skilled in the art that different mathematical computations, such as weighted average of all the response time for collective responses (generated by the server) may be computed to ascertain relevant performance of the mobile application server.

FIG. 4 illustrates a screenshot of a client emulator validating login credentials, in an exemplary embodiment of the present invention.

In an exemplary embodiment of the present invention, multiple instances of a mobile banking application are initiated to test the performance of the mobile banking application server, wherein a mobile banking application is invoked in emulated Blackberry OS™ environment. Thereafter, one or more test cases/test cases, created by the Recording Assistant 206 (FIG. 2), are used to initiate each instance of the mobile banking application. Subsequently, the Client Agent 202A (FIG. 2) in conjunction with the Central Controller 204 (FIG. 2) monitors the response of the mobile banking application by detecting visual changes in the user interface of the mobile banking application. The Client Agent 202A (FIG. 2) is enabled to take snapshot of each visible variation in the user interface of the mobile banking application. The snapshot is further compared to pre-stored snapshots to ascertain the progress/outcome of processing at the mobile banking application. A designated area of the user interface is selected, which identifies the location of message/relevant identification to ascertain the progress of the processing. In an embodiment of the present invention, various pre-stored responses/screenshots depicting different stages/changes in the user interface of a mobile application are stored in the Data Storage Module 210 (FIG. 2).

In an exemplary embodiment of the present invention, a screenshot 402 of an instance of the mobile banking application denotes that the test case inputted in the mobile banking application was not successfully processed. In another exemplary embodiment of the present invention, a screenshot 404 of another instance of the mobile banking application denotes that the test case inputted in the mobile banking application has been successfully processed.

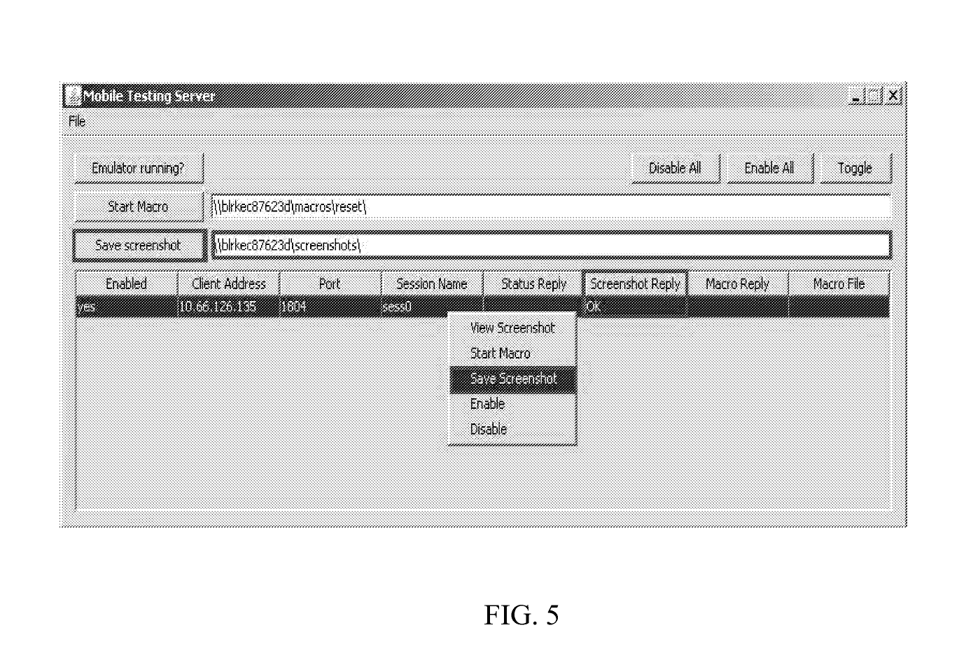

FIG. 5 illustrates a screenshot of a user interface of a central controller module, in an exemplary embodiment of the present invention. The screenshot illustrates a user interface configured to control and monitor one or more instances of a mobile application enabled in a client/server architecture, wherein the mobile application is initiated in the emulation of the Blackberry OS™. The user interface of the Central Controller Module 204 (FIG. 2) comprises various buttons to initiate or stop one or more emulators. Further, the user interface enables a tester/developer to view an online summary report, which outlines the status of each of the emulators (running an instance of a mobile application). The summary report encompasses data such as client address, port of communication, name of session, and so forth. The user interface is further equipped to save the screenshot of an emulated instance at a user defined location, such as the Data Storage Module 210 (FIG. 2).

Various embodiments of the present invention, may be implemented via one or more computer systems. The computer system is not intended to suggest any limitation as to scope of use or functionality of described embodiments. The computer system includes at least one processing unit and memory. The processing unit executes computer-executable instructions and may be a real or a virtual processor. In an embodiment of the present invention, the memory may store software for implementing various embodiments of the present invention.

The present invention may suitably be embodied as a computer program product for use with a computer system. The method described herein is typically implemented as a computer program product, comprising a set of program instructions for controlling a computer or similar device. The set of program instructions may be a series of computer readable instructions fixed on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared or other transmission techniques These instructions can be supplied preloaded into a system or recorded on a storage medium such as a CD-ROM, or made available for downloading over a network such as the Internet or a mobile telephone network. The series of computer readable instructions may embody all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A computer implemented method for testing performance of a mobile application server, the method comprising:
initiating, using a computing device, one or more instances of a mobile application using one or more test cases;
buffering, using a computing device, plurality of requests generated by the one or more instances of the mobile application in response to the corresponding one or more test cases;
invoking, using a computing device, the plurality of buffered requests to a server synchronously based on a predefined policy; and
measuring, using a computing device, the response time taken by the server to process each of the invoked plurality of requests.

2. The computer implemented method of claim 1, wherein the computer implemented method for testing performance of a mobile application server, further comprises:
recording, using a computing device, one or more user inputs, wherein the one or more user inputs are recorded automatically while a user interacts with the mobile application; and
developing, using a computing device, one or more test cases based on the recorded one or more user inputs and pre-stored data.

3. The computer implemented method of claim 2, wherein recording one or more user inputs further comprises converting the one or more recorded user inputs into one or more dynamic test scripts.

4. The computer implemented method of claim 3, wherein developing one or more test cases further comprises processing the one or more dynamic test scripts using the pre-stored data to develop one or more corresponding test cases.

5. The computer implemented method of claim 4, wherein the pre-stored data includes mobile application data, such as Uniform Resource Locator (URL) address of web pages, user transaction details, and so forth.

6. The computer implemented method of claim 1, wherein initiating one or more instances of the mobile application further comprises:
deploying plurality of emulations of an operating system required to host the mobile application in one or more computing devices; and
invoking one or more instances of the mobile application in each of the deployed plurality of emulations of the operating system.

7. The computer implemented method of claim 1, wherein the predefined policy required for invoking the plurality of buffered requests to a server comprises at least one of number of requests buffered, and predetermined time.

8. The computer implemented method of claim 1, wherein measuring the response time taken by the server to process each of the invoked plurality of requests further comprises:
monitoring the request time at which each of the plurality of buffered requests is invoked synchronously to the server;
detecting the processing time at which the server responds after processing each of the plurality of invoked requests; and
deducing the response time based on the monitored request time and detected processing time.

9. The computer implemented method of claim 1, wherein the method for testing performance of a mobile application server further comprises validating, using a computing device, one or more developed test cases by analyzing the user interface of each of the one or more instances of the mobile application and pre-stored information.

10. The computer implemented method of claim 9, wherein the pre-stored information includes targeted screenshots of various responses of the mobile application.

11. A computer implemented method for testing performance of a mobile application server, the method comprising:
recording, using a computing device, one or more user inputs, wherein the one or more user inputs are recorded automatically while a user interacts with a mobile application;
developing, using a computing device, one or more test cases based on the recorded one or more user inputs and pre-stored data;
initiating, using a computing device, one or more instances of the mobile application using one or more test cases;
buffering, using a computing device, plurality of requests generated by the one or more instances of the mobile application in response to the corresponding one or more test cases;
invoking, using a computing device, the plurality of buffered requests to a server synchronously based on a predefined policy; and
measuring, using a computing device, the response time taken by the server to process each of the invoked plurality of requests.

12. A system for testing performance of a mobile application server, the system comprising:
a central controller, in communication with a processor, configured to initiate one or more instances of a mobile application using one or more test cases; and
a message synchronization module, in communication with a processor, configured to:
invoke plurality of buffered requests synchronously to the server based on a predefined policy; and
measure a request response time corresponding to each of the plurality of buffered requests processed at the server.

13. The system of claim 12, wherein the system for testing performance of a mobile application server further comprises a recording assistant, in communication with a processor, configured to develop one or more test cases using one or more user inputs and pre-stored data.

14. The system of claim 13, wherein the recording assistant is further configured to record one or more user inputs, wherein the one or more user inputs are recorded automatically while a user interacts with the mobile application.

15. The system of claim 12, wherein the system for testing performance of a mobile application server further comprises a plurality of client agents, installed in one or more computing devices, configured to initiate one or more instances of the mobile application using the developed one or more test cases.

16. The system of claim 12, wherein the message synchronization module is further configured to buffer requests generated by one or more instances of the mobile application in response to the corresponding one or more test cases.

17. The system of claim 16, wherein the predefined policy used to invoke plurality of buffered requests synchronously to the server for processing comprises at least one of number of buffered requests and predetermined time.

18. The system of claim 15, wherein the plurality of client agents are further configured to capture predefined variations at the user interface of respective instances of the mobile application.

19. The system of claim 17, wherein the central controller is further configured to validate one or more developed test cases by analyzing the captured predefined variations of the user interface of each of the one or more instances of the mobile application and pre-stored information.

20. The system of claim 19, wherein the pre-stored information includes targeted screenshots of various responses of the mobile application.

21. The system of claim 12, wherein the system for testing performance of a mobile application server further comprises a data storage module, in communication with a processor, configured to store the pre-stored data and the pre-stored information.

22. A computer program product comprising a computer usable medium having a computer-readable program code stored thereon, the computer-readable program code comprising instructions that, when executed by a computing device, cause the computing device to:
initiate one or more instances of a mobile application using the developed one or more test cases;
buffer plurality of requests generated by the one or more instances of the mobile application in response to the corresponding one or more test cases;
invoke the plurality of buffered requests to a server synchronously based on a predefined policy; and
measure the response time taken by the server to process each of the invoked plurality of requests.

23. The computer program product of claim 22, wherein the computer-readable code further comprises instructions that, when executed by a computing device, causes the computing device to:
record one or more user inputs, wherein the one or more user inputs are recorded automatically while a user interacts with the mobile application; and
develop one or more test cases based on the recorded one or more user inputs and pre-stored data.

24. The computer program product of claim 23, wherein the computer-readable code further comprises instructions that, when executed by a computing device, causes the computing device to convert the one or more recorded user inputs into one or more dynamic test scripts.

25. The computer program product of claim 24, wherein the computer-readable code further comprises instructions that, when executed by a computing device, causes the computing device to process the one or more dynamic test scripts using the pre-stored data to develop one or more corresponding test cases.

26. The computer program product of claim 22, wherein the computer-readable code further comprises instructions that, when executed by a computing device, causes the computing device to:
deploy plurality of emulations of the operating system required to host the mobile application in one or more computing devices; and
invoke one or more instances of the mobile application in each of the deployed plurality of emulations of the operating system.

27. The computer program product of claim 22, wherein the computer-readable code further comprises instructions that, when executed by a computing device, causes the computing device to:
monitor the request time at which each of the plurality of buffered requests is invoked synchronously to the server;
detect the processing time at which the server responds after processing each of the plurality of invoked requests; and
deduce the response time based on the monitored request time and detected processing time.

28. The computer program product of claim 22, wherein the computer-readable code further comprises instructions that, when executed by a computing device, causes the computing device to validate one or more developed test cases by analyzing the user interface of each of the one or more instances of the mobile application and pre-stored information.
